(19) United States
(12) Patent Application Publication
(10) Pub. No.: US 2026/0335770 A1
(43) Pub. Date: Oct. 29, 2026

(54) APPLICATION PROGRAMMING INTERFACING INTEGRATION USING MACHINE LEARNING

(71) Applicant: SONY INTERACTIVE ENTERTAINMENT INC., Tokyo (JP)

(72) Inventors: Matthew McCallum, Wildomar, CA (US); Christian Rickeby, Trabuco Canyon, CA (US); Richard S. Martin, Laguna Hills, CA (US); Erick Flores, Aliso Viejo, CA (US)

(21) Appl. No.: 19/193,041

(22) Filed: Apr. 29, 2025

(51) Int. Cl. A63F 13/67

(52) U.S. Cl. CPC A63F 13/67; A63F 2300/6009

(57) ABSTRACT

Techniques for described for game development. An example method can include processing an input indicating video game information to be collected during execution of a video game application. The method can further include determining, based on the video game information to be collected, a location in the video game codebase for an application programming interface (API) call insertion, the video game application based on the video game codebase. The method can further include generating an API call based on the video game information to be collected and the location. The method can further include inserting the API call into the video game codebase at the location, the API call configured to request the video game information.

### BACKGROUND

Quality assurance (QA) in video games is a computing system-enabled process for delivering a video game application that provides an error-free and enjoyable gameplay experience to players. QA can include testing the video game application during development to identify and resolve bugs, glitches, and performance issues that could affect gameplay. A computing system can assess the functionality, the usability, and the compatibility of a video game application across various platforms to ensure that the video game application operates as intended under diverse conditions.

### BRIEF SUMMARY

The embodiments described herein provide techniques for assisting an artificial intelligence (AI) agent to collect video game information to be used to play a video game application. A computing system can use a machine learning model to insert an application programming interface (API) call into a video game codebase, which can include the source code for the video game application. During gameplay the API call can cause video game information to be transmitted to the AI agent. The AI agent can use the video game information to play the video game application.

A computing system can be configured to access a video game codebase. The computing system can further provide a machine learning model (e.g., a large language model (LLM) with instructions to analyze the video game codebase to determine where to insert an API call for collecting video game information. The machine learning model can be trained to determine the location for the API call and to generate the API call. The computing system can further insert the API call into the video game codebase. For video game testing purposes (e.g., quality assurance), an AI agent can access a video game application that uses source code from the video game codebase. The AI agent can further play the video game application using video game information collected based on the API call. The AI agent's gameplay can be used as information to improve the video game application.

### BRIEF DESCRIPTION OF THE DRAWINGS

FIG. 1 is an illustration of an example computer system that presents a dashboard, according to one or more embodiments.

FIG. 2 is an illustration of an example computing system for inserting an application programming interface (API) call into a video game codebase, according to one or more embodiments.

FIG. 3 is an illustration of an example computing system for using video game information to play a video game application, according to one or more embodiments.

FIG. 4 is an illustration of an example signaling diagram for inserting API calls into a video game codebase, according to one or more embodiments.

FIG. 5 is an illustration of an example videogame codebase, according to one or more embodiments.

FIG. 6 is an illustration of an example video game codebase with an inserted API call, according to one or more embodiments.

FIG. 7 is an illustration of an example training system for a machine learning model, according to one or more embodiments.

FIG. 8 is an example process for inserting an API call into a video game codebase, according to one or more embodiments.

FIG. 9 is an example process for using video game information for gameplay of a video game application, according to one or more embodiments.

FIG. 10 illustrates an example of a hardware system suitable for implementing a computer system, according to embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

A computing system can be used for video game development to ensure the quality and functionality of a video game application games via testing processes. An automated system can play a role in this domain, as it can be used to identify errors and inconsistencies in a video game's codebase. The computing system can leverage a machine learning model (e.g., a large language model) to process an input indicating video game information that should be collected during a gameplay by an artificial intelligence (AI) agent. As used herein, a video game codebase can include an entire collection of source code used to build a software application, including all related files like configuration files and dependencies, whereas source code can include the individual lines of code written by a programmer within the video game codebase. The machine learning model can analyze the video game codebase to identify data points necessary for the AI agent to navigate the video game application for testing and debugging. The machine learning model can then determine where to insert application programming interface (API) calls within the video game codebase, enabling seamless extraction of relevant information for the AI agent during gameplay. This process can reduce the manual effort required to identify and insert such API calls, enhancing the efficiency and precision of AI agent-enabled video game testing.

Conventional systems for testing video games can face challenges in collecting and interpreting relevant data from the game's codebase. These conventional systems can rely on static or predefined testing scripts that are limited in their ability to adapt to the dynamic nature of video games. As a result, the conventional systems can fail to capture nuanced gameplay interactions or unexpected behaviors, leading to incomplete or inaccurate testing. Furthermore, conventional systems can require manual intervention to identify code locations where API calls should be inserted, making the conventional process time-consuming and error-prone. The conventional system can be inaccurate due to missed errors, inefficiencies, and delays in the game development lifecycle, particularly as video games grow increasingly complex.

The embodiments herein address the above-described challenges by providing techniques for using a machine learning model to identify locations in the video game codebase to insert an API call, and to generate the API call. The techniques described herein can be used to provide an AI agent with video game information by collecting real-time gameplay data and relevant code execution details. The machine learning model can have the ability to interpret the input specifying the video game information to be collected to generate API calls that are tailored to the specific testing requirements. This not only helps the AI agent play the game more effectively by providing detailed insights into game mechanics and behavior but also allows the AI agent to identify errors, bugs, or performance issues with greater precision.

The techniques described herein can enhance the testing process for a video game application. The machine learning model can identify an appropriate location in the codebase to insert an API call. The machine learning model can then generate the API call that is customized to request the specified video game information. The machine learning model can then insert the API call into the codebase at the determined location, and without disrupting the game's overall functionality. By automating the generation and insertion of API calls, the computing system can reduce the risk of human error and enable the continuous testing throughout the development cycle.

The herein described techniques can provide several technical advantages over conventional systems. For example, by leveraging a machine learning model, the herein described computing system can dynamically identify optimal locations in the codebase for API call insertion, eliminate the need for manual code analysis, and reduce the potential for human error. Additionally, the generation and insertion of API calls by the machine learning model can allow for the relevant video game information to be collected in real-time, enabling a more comprehensive understanding of game mechanics and performance. The herein described techniques also allow for adaptive testing, as the machine learning model can adjust to changes in the codebase or evolving testing requirements without requiring extensive reconfiguration. These technical advantages can not only streamline the video game application testing process, but also improve the reliability of error detection and resolution, which can accelerate development timelines and enhance the overall quality of the final video game application.

In the interest of clarity of explanation, the embodiments may be described in connection with a video game system including a video game console. However, the embodiments are not limited as such and similarly apply to any other type of a computer system. Generally, a computer system presents a dashboard in a graphical user interface (GUI) on a display. The dashboard presents user interface (UI) elements, each corresponding to an application, service, or collection of information.

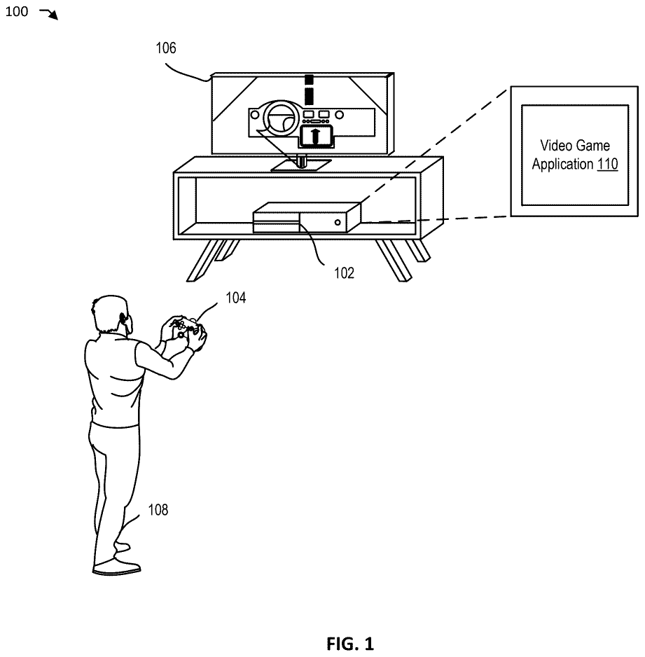

FIG. 1 is an illustration 100 of an example computer system that presents a dashboard, according to an embodiment of the present disclosure. As illustrated, the computer system includes a video game console 102, a video game controller 104, and a display 106. Although not illustrated, the computer system may also include a backend system, such as a set of cloud servers, that is communicatively coupled with the video game console 102. The video game console 102 is communicatively coupled with the video game controller 104 (e.g., over a wireless network) and with the display 106 (e.g., over a communications bus). A video game player 108 operates the video game controller 104 to interact with the video game console 102. These interactions may include playing a video game presented on the display 106, interacting with a menu presented on the display 106, and interacting with other applications of the video game console 102 (e.g., with media applications to stream media from an online content source or to play a media file from the local storage of the video game console 102).

The video game console 102 includes a processor and a memory (e.g., a non-transitory computer-readable storage medium) storing computer-readable instructions that can be executed by the processor and that, upon execution by the processor, cause the video game console 102 to perform operations related to various applications. In particular, the computer-readable instructions can correspond to program codes for the various applications of the video game console 102 including video game application 110, video game application 112, controller application 114, and audio application 116. A video game application, such as video game application 112, generally represents a computer application executable to present video game content, receive user interaction with the video game content, and accordingly update the video game content. The availability of a video game application, and/or other type of computer application to the video game player 108 via the video game console 102 can depend on a user identifier of the video game player 108 (e.g., upon a login to the video game console 102, the availability of the computer applications can depend on the user identifier used in the login).

The video game application 110 can present image information, such as the visual frames of the video application. In response to an interaction with a video game controller 104, the video game application 110 can display a movement in the video game application that corresponds to the interaction. For example, if the video game controller 104 is interacted with to indicate forward motion, the video game application can cause an image of a character to appear to move forward. The video game application can further present audio corresponding to the video game application. The audio information can include, for example, music presented during game play.

The video game controller 104 is an example of an input device. The video game controller 104 may allow the video game player 108 to interact with one or more GUIs presented by the video game console 102 on the display 106. For example, using one or more directional control inputs (e.g., a joystick and/or a directional pad) the user can navigate to and within various menus, dashboards, and UI elements. The interaction with the video game controller 104 can be converted into electrical signals and transmitted to a cloud server as controller information. Other types of the input device are possible including, a keyboard, a touchscreen, a touchpad, a mouse, an optical system, a microphone, a camera, or other user devices suitable for receiving input of a user. For example, a microphone may allow the video game player 108 to interact with the GUIs using various voice commands. As another example, a camera may allow the video game player 108 to interact with the GUIs using various gesture commands.

Upon an execution of the video game application 110 by the video game console 102, a rendering process of the video game console 102 presents video game content (e.g., illustrated as a car race video game content) on the display 106. Upon user input from the video game controller 104 (e.g., a user push of a particular key or button), the rendering process also presents the menu. Additionally, or alternatively, the menu may be presented as an initial landing page in response to a user powering-on the video game console 102 and/or waking the video game console 102 from a suspended state. Depending on the user input, the menu corresponds to the home UI page, a landing page, or the like. The menu can be presented in a layer over the video game content.

Although FIG. 1 illustrates that the different applications are executed on the video game console 102, the embodiments of the present disclosure are not limited as such. Instead, the applications can be executed on the backend system (e.g., the cloud servers) and/or their execution can be distributed between the video game console 102 and the backend system.

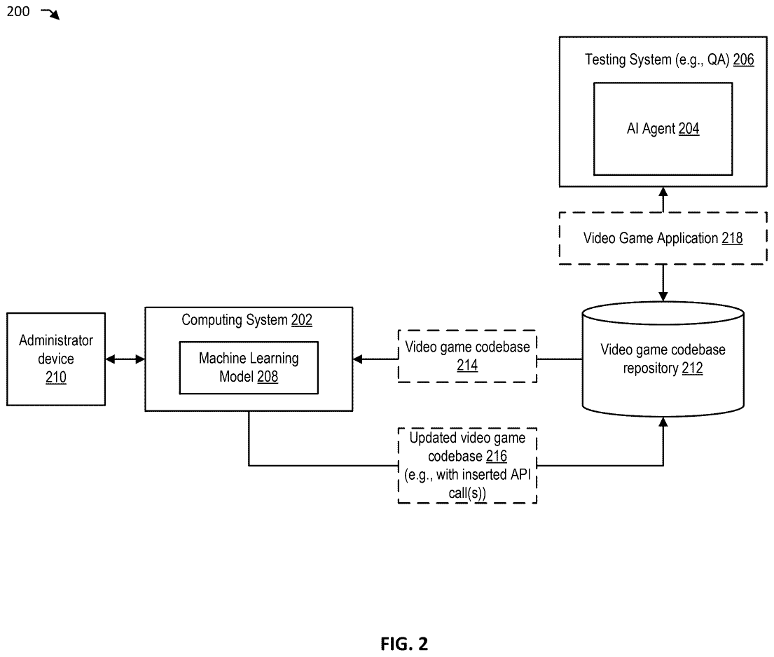

FIGS. 2-4 relate to a computing system used to insert an API call into a video game codebase.

FIG. 2 is an illustration 200 of an example computing system for inserting an API call into a video game codebase, according to one or more embodiments. As illustrated, a computing system 202 can include a machine learning model (e.g., a large language model (LLM)) for the process of analyzing a video game codebase (e.g., source code) and inserting one or more application programming interface (API)) calls into the video game codebase. An API call can be a request sent to the video game codebase to perform a specific function or retrieve information. The embodiments herein describe techniques for API calls to be used to collect specific video game information during gameplay by an artificial intelligence (AI) agent 204, As illustrated, the AI agent 204 is being run by a testing system 206. However, it should be appreciated that in other instances, the AI agent 204 can be executed by a game server during a live gaming session. The video game information can include for example, performance metrics, player statistics, interaction logs, current world state, available actions, non-player character (NPC) interactions, or game event updates.

The computing system 202 can run a machine learning (ML) model 208 that can interface with an administrator device 210. In some instances, the administrator device 210 can provide instructions as to one or more types of video game information to collect. In other instances, the ML model 208 determines the types of video game information to collect. The computing system 202 can be used to access a video game codebase repository 212 that stores the video game codebase 214. In some embodiments, the computing system can download the video game codebase 214. In these embodiments, the ML model 208 can insert the API calls into the video game codebase at the computing system 202, and then return the updated video game codebase to the video game codebase repository 212. In other embodiments, the ML model 208 can access the video game codebase at the video game codebase repository 212 and the updating can be performed at the video game codebase repository 212.

The ML model 208 can be an LLM. The LLM can be trained to perform a series of steps to analyze the video game codebase 214 and determine where to insert API calls, as well as to generate the API calls themselves. First, the LLM can parse the video game codebase 214 to construct an abstract representation of its structure, such as an abstract syntax tree (AST) or control flow graph. This LLM can use the representation to understand the logical flow of the video game codebase 214, including function definitions, conditional statements, loops, and data dependencies. By examining these elements, the LLM can identify key areas in the video game codebase 214 that may be critical for gameplay mechanics, performance monitoring, or user interaction.

In some embodiments, the LLM can apply a pre-defined criteria provided the administrator device 210. These criteria can include specific data collection goals (e.g., performance metrics, interaction logs), the location of key events (e.g., player actions, system updates), or regions in the video game application with potential performance bottlenecks. The LLM can be trained on similar video game codebases to understand coding patterns and to evaluate the relevance of each candidate location for an API call. The LLM can also be trained to perform a risk assessment to ensure that the insertion of API calls will not adversely affect the video game codebase's functionality or performance.

The LLM can determine locations for one or more API calls and generate the API calls. For example, the LLM can synthesize code snippets that align with the defined parameters for desired video game information. For example, if the API call is intended to collect player movement data, the LLM can generate a function or method that logs player coordinates during specific in game events. The LLM can generate API calls that are compatible with the existing video game codebase by using language-specific syntax to integrate the API calls with the video game codebase 214. In some embodiments, the LLM may also use an error-handling mechanisms to determine whether the API calls function reliably during gameplay.

The LLM can insert the generated API calls into the identified locations in the video game codebase 214. In some embodiments, the LLM can validate the updated video game codebase 216 through analysis or test runs.

In some instances, the computing system 202 downloaded the video game codebase 214, the updated video game codebase 216 can be transmitted to the video game codebase repository 212. In embodiments that the machine learning model accessed the video game codebase 214 at the video game codebase repository 212, the updated video game codebase 216 can be stored at the video game codebase repository 212.

In some embodiments, the testing system 206 can access the updated video game codebase 216 from the video game codebase repository 212. The testing system 206 can include an AI agent that is configured to interact with video game application that uses the updated video game codebase 216. For example, the updated video game codebase 216 can include the source code for the video game application. The AI agent 204 can simulate various gameplay scenarios, triggering the inserted API calls to collect the video game information during gameplay. The AI agent 204 can further use the video game information as a basis for gameplay decisions.

The AI agent's performance can be analyzed to determine the video game information's impact on the AI agent's performance, during the gameplay of the video game application. Based on the performance, the ML model 208 can update (e.g., modify, delete) the API calls or add one or more additional API calls.

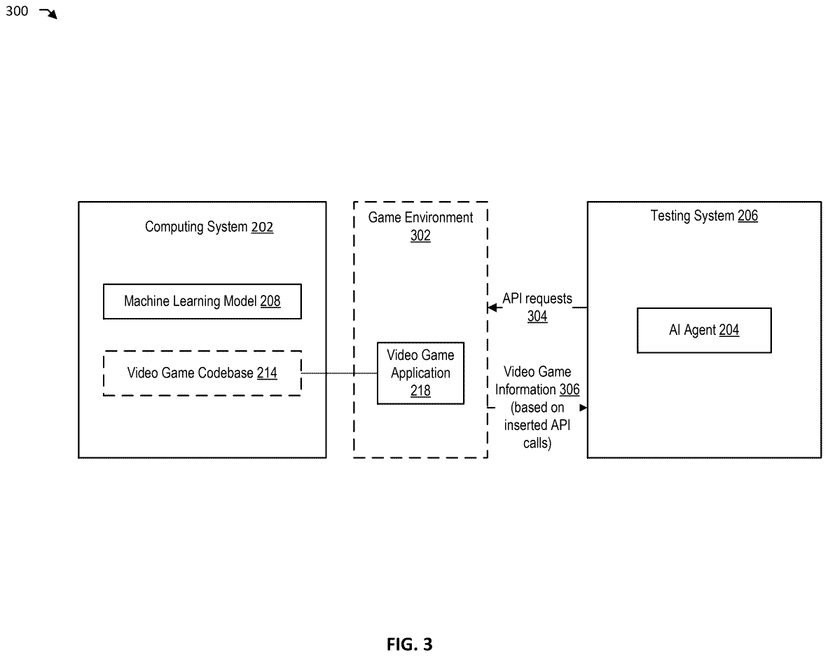

FIG. 3 is an illustration 300 of an example computing system for using video game information to play a video game application, according to one or more embodiments. As illustrated, the computing system 202 can use a machine learning model 208 to analyze a video game codebase 214 to identify potential integration points for API calls. These API calls can be designed by the machine learning model 208 to extract relevant video game data and relay it to an external system. The external system can be a testing system 206, in which an AI agent 204 can play a video game application that is based on the video game codebase 214.

As indicated above, the machine learning model 208 can insert one or more API calls into the video game codebase 214, Upon the insertion of the one or more API calls, the computing system 202 can transmit a message to the testing system 296 that the video game application is ready for testing. The testing system can initialize the AI agent 204 and a game environment 302. The game environment 302 can be, for example, a gaming platform existing on a server, (e.g., cloud-based gaming platform instance, gaming platform instance, or other gaming platform) for executing a video game application that is based on the video game codebase. In some embodiments, the game environment 302 can access a video game codebase repository 212 to access an updated video game codebase 216 to be used for the video game application 218.

The AI agent 204 can play the video game application 218 (e.g., Horizon Zero Down, God of War, or other video game application) on the game environment 302. For example, the game environment can compile the videogame codebase 216 to permit gameplay of a video game application. The AI agent 204 can play the video game application 218 via the API requests 304. For example, the AI agent 204 can transmit an API request to cause a character to move in direction, to use a tool, interact with another video game character, change a game setting or other video game action. For example, the AI agent 204 can transmit an API request 304 to the game environment 302 to cause a video game character to move forward. Based on the gameplay of the AI agent 204 video game information can continuously be generated. The video game information can include, for example, the current state of the game, player positions, game objects, and other in game variables.

Based on the API calls that have been inserted into the video game codebase 214, some or all of the video game information 306 can be transmitted to the AI agent 204 during gameplay. This video game information 306 can form a basis for enabling real-time interaction between the video game application 218 and the AI agent 204. The AI agent 204 can use the video game information 306 to interact with the game. The AI agent 204 can process the received video game information 306 and make decisions and execute actions within the game environment 302. For example, the video game information 306 can indicate that the AI agent's player is low on health. In response, the AI agent 204 can transmit an API request 304 to cause the character to drink a heath potion. The video game information 306 can enable the AI agent 204 to simulate gameplay and analyze game mechanics. In some embodiments, the testing system 206 can serve as a platform for evaluating the video game application 218 and the AI agent's performance. In other embodiments, the computing system 202 can serve as a platform for evaluating the video game application 218 and the AI agent's performance. In other embodiments, the

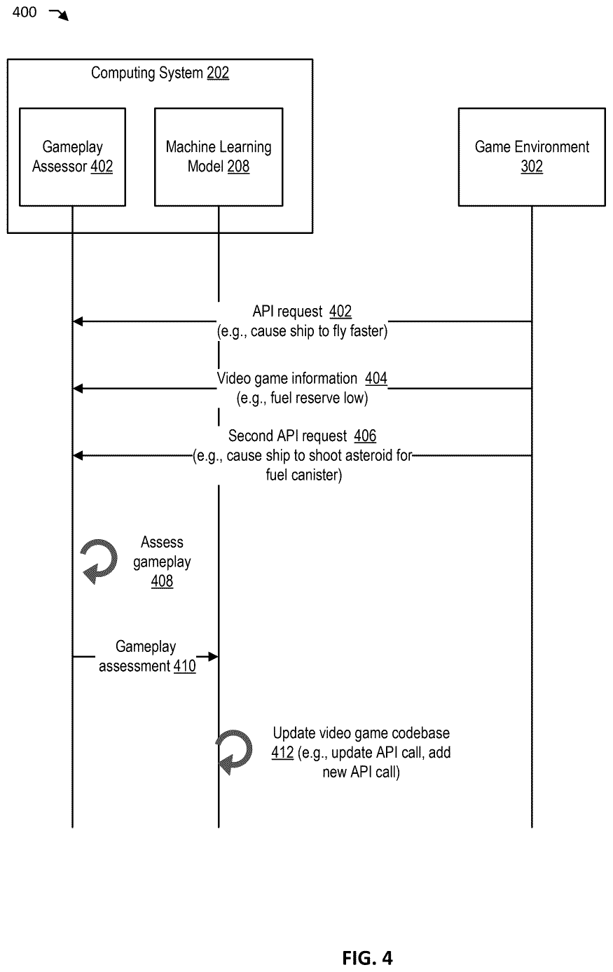

FIG. 4 is an illustration 400 of an example signaling diagram for inserting API calls into a video game codebase, according to one or more embodiments. As illustrated, a computing system 202 can be in communication with a game environment 302. As indicated with respect to FIG. 3, an AI agent can engage in gameplay of a video game application via a game environment.

At 402, the game environment 302 can transmit to a gameplay assessor 402, an API request that was transmitted by an AI agent to the game environment 302. For example, the AI agent may have transmitted an API request to cause a ship in a video game application to fly faster. At 404, the game environment 302 can transmit video game information that was generated based on an inserted API call. For example, the video game information can include an indication of a low fuel reserve. In the video game application, the low fuel reserve can be based on the additional fuel used to cause the ship to fly faster.

At 406, the game environment 302 can transmit to the game assessor 402, a second API request that was transmitted by an AI agent to the game environment 302. For example, the second API request can be for the ship to shoot asteroids to collect new fuel cannisters.

At 408, the game assessor 402, which can include a machine learning model, can assess the gameplay of the AI agent. The gameplay can be assessed based on an API request, video game information generated based on a video game action caused by the API request, and a subsequent API request after action that caused the video game information to be generated. The assessment can include, for example, that the video game information did or did not correspond to the API request, additional video game information was generated, but not transmitted to the AI agent, the second API request was not based on the video game information, given different video game information, the AI agent may have transmitted a different API request for a different action (e.g., information about a nearby station may have caused AI agent to cause ship to land at station). At 410, the gameplay assessor 402 can transmit the gameplay assessment to the machine learning model 208.

At 412, based on the gameplay assessment, the machine learning model 206 can update the video game codebase. For example, the machine learning model 206 can update the API call by either changing the API call, moving a location of the API call, or deleting the API call. The machine learning model 206 can also add a new API call that is configured to request different information than the one or more of the existing API calls inserted into the video game codebase.

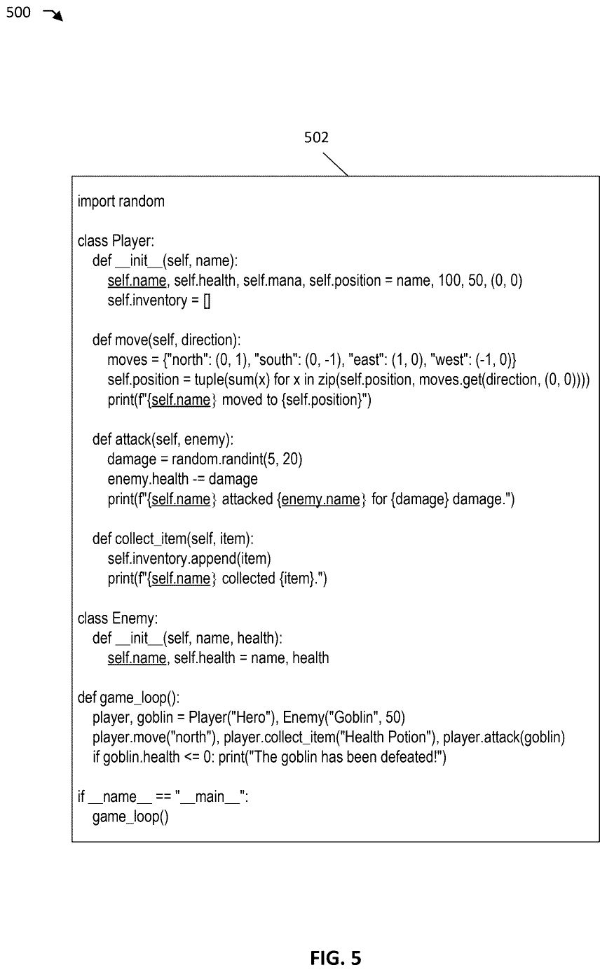

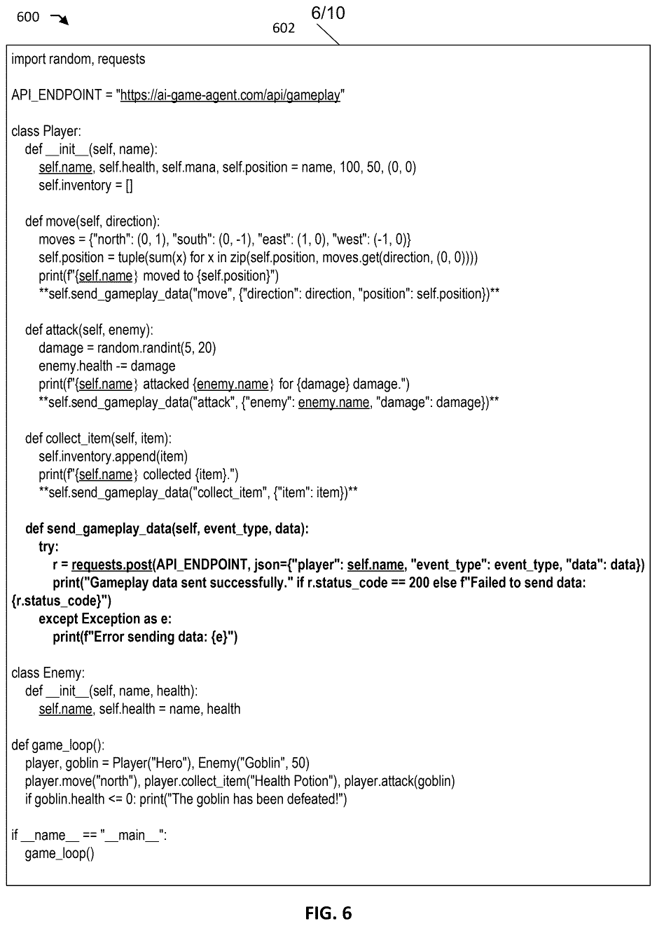

FIGS. 5 and 6 relate to examples of a video game codebase.

FIG. 5 is an illustration 500 of an example video game codebase, according to one or more embodiments. The example video game codebase can define a basic structure for a text-based role-playing game (RPG) using Python, featuring a player and an enemy. The player class can represent the main character of the game, encapsulating attributes such as the player's name, health, mana, position (represented as a two dimensional (2D) coordinate), and an inventory for storing collected items. The class can provide several methods for interaction within the game world: move, which updates the player's position based on directional input using a predefined mapping of directions to coordinate changes; attack, which simulates combat by randomly generating damage within a range and reducing the enemy's health accordingly; and collect_item, which allows the player to add items to their inventory.

The enemy class can model an adversary in the game, with attributes for the enemy's name and health. The game_loop function can orchestrate gameplay by creating a player object and an enemy object (a goblin), demonstrating a sequence of actions: the player moves north, collects a health potion, and attacks the goblin. The result of the attack is checked, and if the goblin's health falls to zero or below, a victory message is displayed. This code can integrate randomness in the attack mechanics, ensuring variability in damage dealt during combat, which adds an element of unpredictability to gameplay. It should be appreciated that this is an example video game codebase and in a real world application, the codebase may be different.

FIG. 6 is an illustration 600 of an example video game codebase with an inserted API call, according to one or more embodiments. As indicated above, the video game code can define a Python-based framework for a simple role-playing game (RPG) that incorporates API communication to send gameplay data to an external server. The main components of the code include a player class, an enemy class, and a game_loop function, with the key addition of an API call mechanism in the player class.

The player class represents the player character and includes attributes like the player's name, health, mana, position (a tuple representing 2D coordinates), and an inventory for storing collected items. The class provides methods for gameplay interactions: First, move (direction): can updates the player's position based on the direction specified (e.g., “north”, “south”). The new position is calculated using a predefined mapping of directions to coordinate changes. After updating the position, the move method calls the send_gameplay_data function to send data about the movement event to the API endpoint. The data includes the direction of movement and the updated position. Second, attack(enemy): can simulate combat by randomly generating damage (between 5 and 20) and subtracting it from the enemy's health. After performing the attack, the attack method invokes the send_gameplay_data function to transmit information about the attack event to the API. This data includes the enemy's name and the amount of damage dealt. Third, collect_item (item): can adds an item to the player's inventory and subsequently calls the send_gameplay_data function to send data about the item collection event to the API. The transmitted data includes the name of the collected item.

The send_gameplay_data method is an enhancement to the player class, enabling real-time communication with an external API (e.g., to connect with the AI agent 204) at the endpoint https://ai-game-agent.com/api/gameplay. This method can send a POST request with a JSON payload containing the player's name, the type of event (e.g., “move”, “attack”, “collect_item”), and event-specific data. It also includes error handling to manage potential exceptions and provides feedback on the success or failure of the API call.

The game_loop function can demonstrate a sequence of gameplay actions: the player moves north, collects a health potion, and attacks a goblin enemy. Each of these actions can triggers an API call through the send_gameplay_data method, ensuring that the external server receives updates about the player's activities. If the goblin's health is reduced to zero or below, a victory message is displayed. It should be appreciated that this is an example video game codebase and in a real world application, the codebase may be different.

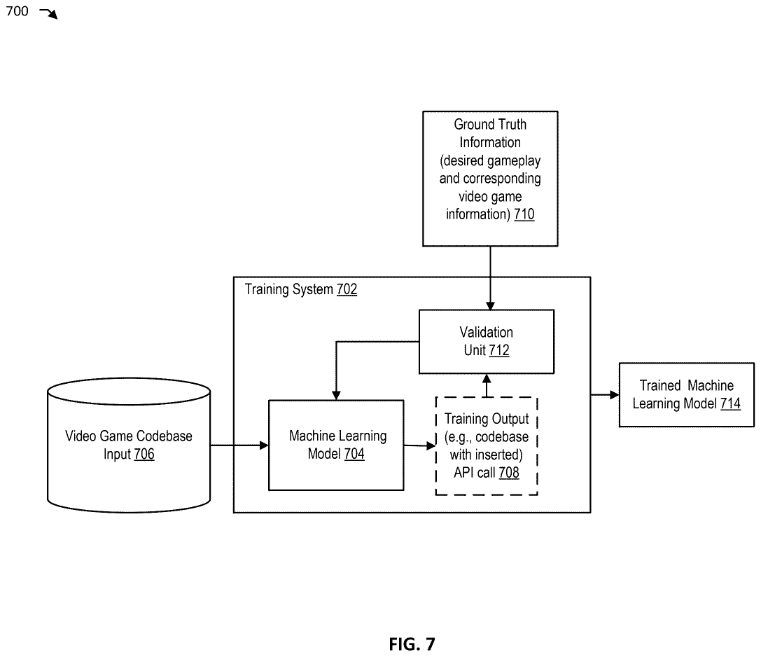

FIG. 7 is an illustration 700 of an example training system for a machine learning model, according to one or more embodiments. As illustrated, a training system 702 can be configured to train a machine learning model 704 to be capable of processing a video game codebase, determine video game information that can be used to play a video game application, determine a location for an API call to be inserted, generate the API call to collect the information, and insert the API call into the video game codebase. The training system 702 can receive a video game codebase input 706 as an input. This input can represent a video game codebase that can based to run a video game application. The video game codebase input 706 can be processed by the machine learning model 704. The machine learning model 704 can generate a training output 708, which can include a video game codebase with an API call inserted.

To guide the training process, the training system 702 can use ground truth information 710, which can act as a reference dataset containing predefined mappings between desired gameplay and their corresponding video game information. The training system 702 can provide the ground truth information 710 to the validation unit 712, which can evaluate the training output 708 generated by the machine learning model 704. For example, the validation unit 712 can compare the model's training output 708 against the ground truth information 710 and assess its accuracy and relevance. For example, the validation unit 712 can determine whether the generated API calls would result in collecting video game information that is relevant for desirable gameplay. Through this comparison, the training system 702 system can identify discrepancies and provides feedback to refine the machine learning model 704.

To improve the accuracy, the training system 702 can of update the weights of the machine learning model 704. This training output 708 can be iteratively refined as the machine learning model 704 undergoes additional training cycles. The feedback loop ensures that the machine learning model 704 can learn to produce accurate and appropriate results over time.

Once the training process achieves a satisfactory level of accuracy and consistency, the training system 702 can output the trained machine learning model 714. This trained machine learning model 714 can be capable of analyzing video game codebase and inserting API calls in the appropriate locations of the video game codebase.

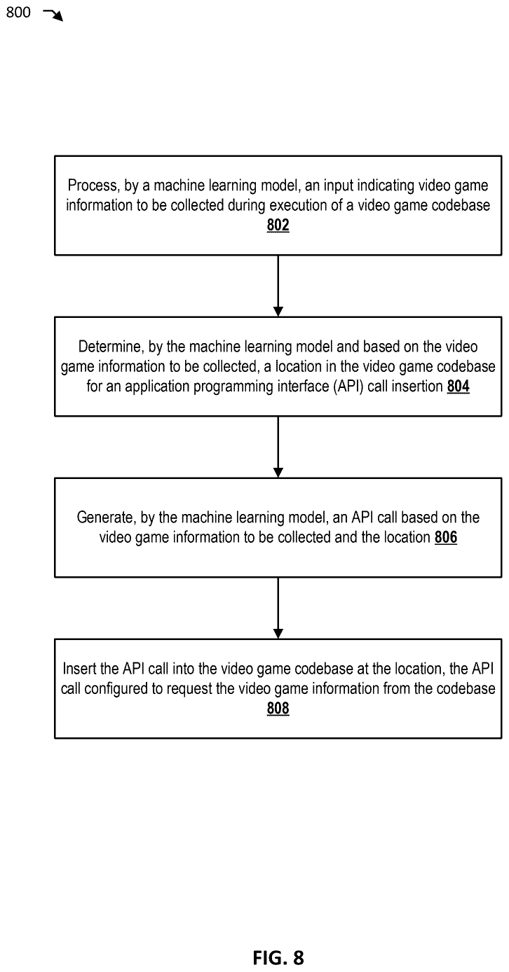

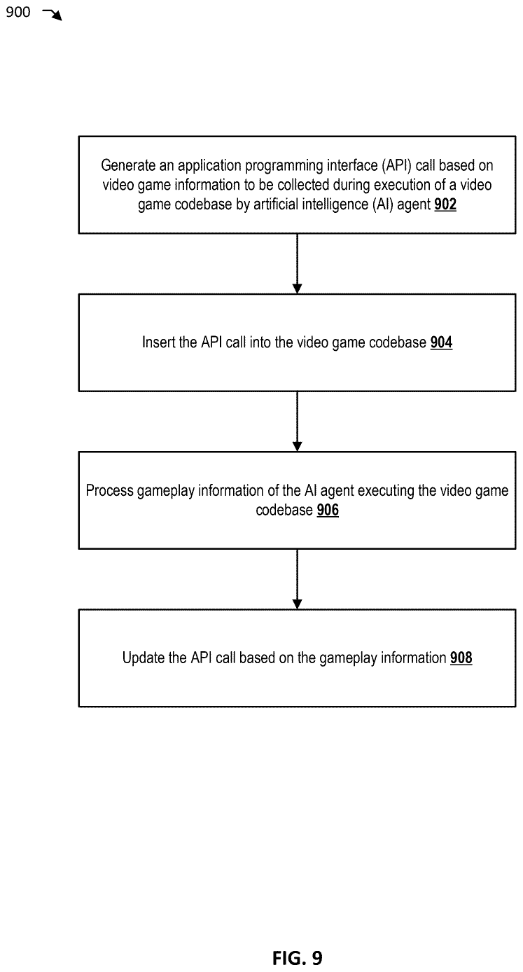

FIGS. 8 and 9 relate processes for inserting API calls into a video game codebase.

FIG. 8 is an example process 800 for inserting an API call into a video game codebase, according to one or more embodiments. At 802, the process 800 can include a computing system (e.g., computing system 202 via machine learning model 208) processing an input indicating video game information to be collected during execution of a video game application.

In some embodiments, the input can include a file indicating a type of video game information to be collected, a structure of the video game information to be collected, and an endpoint for an AI agent. In some embodiments, the video game information include one of the following: current world state, available actions, non-player character (NPC) interactions, or game event updates.

In some embodiments, the computing system can access a set of predefined prompts. The computing system can then determine that an AI agent is to play a video game application associated with the video game codebase. The computing system can then select a predefined prompt of the set of predefined prompts.

At 804, the process 804 can include the computing system determining, based on the video game information to be collected, a location in the video game codebase for an API call insertion. The video game application can be based on the video game codebase.

At 806, the process 800 can include the computing system generating an API call based on the video game information to be collected and the location.

At 808, the process 800 can include the computing system inserting the API call into the video game codebase at the location, the API call configured to request the video game information. In some embodiments, the computing system can insert a second API call into the video game codebase, wherein the second API call is configured to collected second video game information based on a value of the video game information.

In some embodiments, the computing system can insert a natural language comment into the video game codebase, the natural language comment describing a purpose for inserting the API call. The computing system can then process, by the machine learning model, the natural language comment. The computing system can then determine whether to insert a second API call into the video game codebase based on processing the natural language comment.

In some embodiments, a plurality of API calls are inserted in the video game codebase including the API call. In these embodiments, the computing system can process a merge request associated with the plurality of API calls and the video game codebase, the merge request for permitting a respective acceptance or rejection of each API call of the plurality of API calls. The computing system can then update the machine learning model based on the respective acceptance or rejection of each API call. For example, the weights of the model can be updated based on whether the API calls are accepted or rejected.

In some embodiments, the API call is configured to collect information for an AI agent configured to play a video game application that is based on the video game codebase. In these embodiments, the computing system can monitor a gameplay of the AI agent while playing the video game application. The computing system can determine an association between the video game information collected via the API call and the gameplay. The computing system can then update the input based on the association. For example, the input can be updated to indicate collecting video game information that the AI agent can use based on the monitored gameplay.

In some embodiments, while monitoring or after monitoring the gameplay, the computing system can determine that the gameplay of the AI agent can be modified (e.g., improved based on additional video game information) based on second video game information. The computing system can then insert a second API call into the codebase for collecting the second video game information.

In some embodiments, the monitoring a first gameplay of an AI agent playing a video game application that is based on the video game codebase. The computing system can then insert a second API call for collecting second video game information into the video game codebase. The computing system can then monitor, after inserting the second API call, a second gameplay of the AI agent. The computing system can then compare the first gameplay and the second gameplay. The computing system can then determine whether to remove the second API call based on comparing the first gameplay and the second gameplay.

In some embodiments, the computing system can insert an API call indicator for marking a location of the API call. The computing system can then determine that a quality assurance (QA) testing session has concluded. The computing system can then remove the API call from the video game codebase based on determining that the QA session has concluded and based on the API call indicator.

In some embodiments, the computing system can transmit the video game information to an AI agent, wherein the AI agent controls a non-player character (NPC) during gameplay. The computing system can then monitor an interaction between the NPC and a player character. The computing system can then determine whether to remove the API call based on monitoring the interaction.

FIG. 9 is an example process 900 for using video game information for gameplay of a video game application, according to one or more embodiments. At 902, the process 900 can include a computing system (e.g., computing system 202 via machine learning model 208) generating an API call based on video game information to be collected during execution of a video game codebase by an AI agent (e.g., AI agent 204). In some embodiments, the API call can be used to provide contextual information to the AI agent. In some further embodiments, the context information can be determined based on processing video game information, such as video information (e.g., image frames), audio information (e.g., audio files), and controller information (e.g., controller input or API call information). For example, as the AI agent is playing the video game application (or in some instances a player is playing the game), the video game information resulting from the gameplay can be provided to the computing system. The computing system can determine based on the video game information, what context information the AI agent may need for a task (e.g., gameplay, testing an aspect of the video game such as physic engine, breakpoints or other aspect, or other task). The context information can include information that can influence the AI agent's interaction with the video game application. For example, for a gameplay task, the context information can include an objective, a state, or available inventory. In another example, for a physics engine testing task, the context information can include relative positions of a character and objects that the character can interact with. Based on the task, the computing system can determine the API call and where to insert the API call in the video game codebase.

At 904, the process 900 can include the computing system inserting the API call into the video game codebase.

At 906, the process 900 can include the computing system processing gameplay information of the AI agent executing the video game codebase. At 908, the process 900 can include the computing system processing gameplay information of the AI agent executing the video game codebase.

At 910, the process 900 can the computing system updating the API call based on the gameplay information. In some embodiments, the computing system can insert a second API call into the video game codebase based on the gameplay information. In some other embodiments, the computing system can process a message from the AI agent during execution of the video game codebase. The computing system can then generate a second API call based on the message. The computing system can then insert the second API call in the video game codebase during execution of the video game codebase by the AI agent.

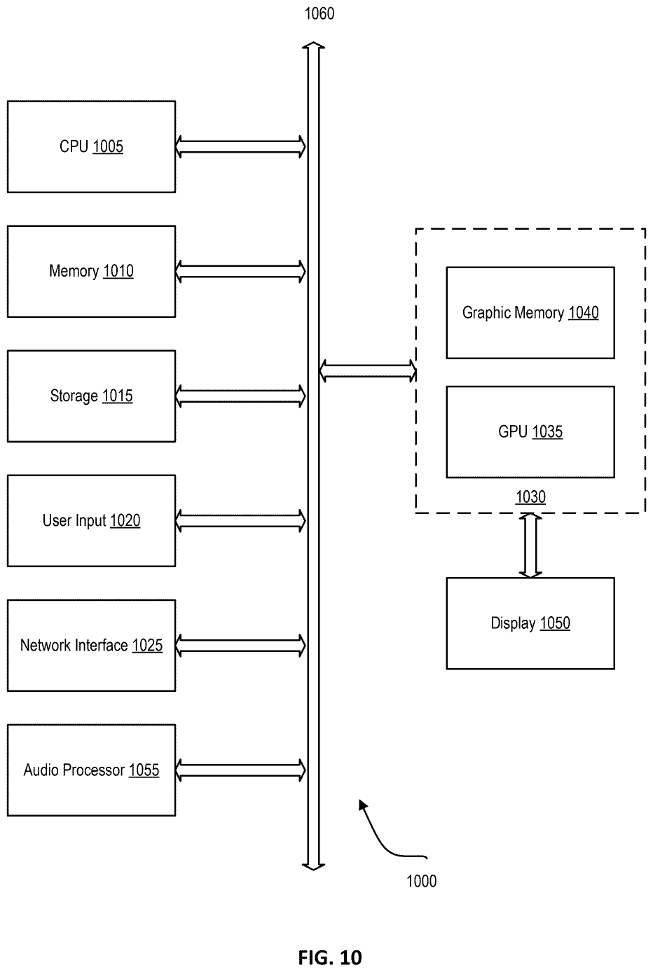

FIG. 10 illustrates an example of a hardware system suitable for implementing a computer system, according to embodiments of the present disclosure. The computer system 1000 represents, for example, a video game system, a backend set of servers, or other types of a computer system. The computer system 1000 includes a central processing unit (CPU) 1005 for running software applications and optionally an operating system. The CPU 1005 may be made up of one or more homogeneous or heterogeneous processing cores. Memory 1010 stores applications and data for use by the CPU 1005. Storage 1015 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1020 communicate user inputs from one or more users to the computer system 1000, examples of which may include keyboards, mice, joysticks, touch pads, touch screens, still or video cameras, and/or microphones. Network interface 1025 allows the computer system 1000 to communicate with other computer systems via an electronic communications network, and may include wired or wireless communication over local area networks and wide area networks such as the Internet. An audio processor 1055 is adapted to generate analog or digital audio output from instructions and/or data provided by the CPU 1005, memory 1010, and/or storage 1015. The components of computer system 1000, including the CPU 1005, memory 1010, data storage 1015, user input devices 1020, network interface 1025, and audio processor 1055 are connected via one or more data buses 1060.

A graphics subsystem 1030 is further connected with the data bus 1060 and the components of the computer system 1000. The graphics subsystem 1030 includes a graphics processing unit (GPU) 1035 and graphics memory 1040. The graphics memory 1040 includes a display memory (e.g., a frame buffer) used for storing pixel data for each pixel of an output image. The graphics memory 1040 can be integrated in the same device as the GPU 1035, connected as a separate device with the GPU 1035, and/or implemented within the memory 1010. Pixel data can be provided to the graphics memory 1040 directly from the CPU 1005. Alternatively, the CPU 1005 provides the GPU 1035 with data and/or instructions defining the desired output images, from which the GPU 1035 generates the pixel data of one or more output images. The data and/or instructions defining the desired output images can be stored in the memory 1010 and/or graphics memory 1040. In an embodiment, the GPU 1035 includes 3D rendering capabilities for generating pixel data for output images from instructions and data defining the geometry, lighting, shading, texturing, motion, and/or camera parameters for a scene. The GPU 1035 can further include one or more programmable execution units capable of executing shader programs.

The graphics subsystem 1030 periodically outputs pixel data for an image from the graphics memory 1040 to be displayed on the display device 1050. The display device 1050 can be any device capable of displaying visual information in response to a signal from the computer system 1000, including CRT, LCD, plasma, and OLED displays. The computer system 1000 can provide the display device 1050 with an analog or digital signal.

In accordance with various embodiments, the CPU 1005 is one or more general-purpose microprocessors having one or more processing cores. Further embodiments can be implemented using one or more CPUs 1005 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method implemented by a computing system, the method comprising:
processing, by a machine learning model, an input indicating video game information to be collected during execution of a video game application;
determining, by the machine learning model and based on the video game information to be collected, a location in a video game codebase for an application programming interface (API) call insertion, the video game application based on the video game codebase;
generating, by the machine learning model, an API call based on the video game information to be collected and the location; and
inserting the API call into the video game codebase at the location, the API call configured to request the video game information.

2. The method of claim 1, wherein a plurality of API calls are inserted in the video game codebase including the API call, and wherein the method further comprises:
processing a merge request associated with the plurality of API calls and the video game codebase, the merge request for permitting a respective acceptance or rejection of each API call of the plurality of API calls; and
updating the machine learning model based on the respective acceptance or rejection of each API call.

3. The method of claim 1, wherein the API call is configured to collect information for an artificial intelligence (AI) agent configured to play a video game application that is based on the video game codebase, and wherein the method further comprises:
monitoring a gameplay of the AI agent while playing the video game application;
determining an association between the video game information collected via the API call and the gameplay; and
updating the input based on the association.

4. The method of claim 3, wherein method further comprises:
determining that the gameplay of the AI agent can be modified based on second video game information; and
inserting a second API call into the video game codebase for collecting the second video game information.

5. The method of claim 1, wherein the input comprises a file indicating a type of video game information to be collected, a structure of the video game information to be collected, and an endpoint for an AI agent.

6. The method of claim 1, wherein the method further comprises:
accessing a set of predefined prompts;
determining that an AI agent is to play a video game application associated with the video game codebase; and
selecting a predefined prompt of the set of predefined prompts based on determining that the AI agent is to play the video game application, wherein the input comprising the prompt.

7. The method of claim 1, wherein the method further comprises:
inserting a natural language comment into the video game codebase, the natural language comment describing a purpose for inserting the API call;
processing, by the machine learning model, the natural language comment; and
determining whether to insert a second API call into the video game codebase based on processing the natural language comment.

8. The method of claim 1, wherein the video game information comprises one of the following: current world state, available actions, non-player character (NPC) interactions, or game event updates.

9. The method of claim 1, wherein the method further comprises:
monitoring a first gameplay of an AI agent playing a video game application that is based on the video game codebase;
inserting a second API call for collecting second video game information into the video game codebase;
monitoring, after inserting the second API call, a second gameplay of the AI agent;
comparing the first gameplay and the second gameplay; and
determining whether to remove the second API call based on comparing the first gameplay and the second gameplay.

10. The method of claim 1, wherein the method further comprises:
inserting an API call indicator for marking a location of the API call;
determining that a quality assurance (QA) testing session has concluded; and
removing the API call from the video game codebase based on determining that the QA session has concluded and based on the API call indicator.

11. The method of claim 1, wherein the method further comprises:
inserting a second API call into the video game codebase, wherein the second API call is configured to collected second video game information based on a value of the video game information.

12. The method of claim 1, wherein the method further comprises:
transmitting the video game information to an AI agent, wherein the AI agent controls a non-player character (NPC) during gameplay;
monitoring an interaction between the NPC and a player character; and
determining whether to remove the API call based on monitoring the interaction.

13. A computing system comprising:
one or more processors; and
one or more computer readable media comprising a sequence of instructions that, when executed, cause the one or more processors to:
process, by a machine learning model, an input indicating video game information to be collected during execution of a video game application;
determine, by the machine learning model and based on the video game information to be collected, a location in a video game codebase for an application programming interface (API) call insertion, the video game application based on the video game codebase;
generate, by the machine learning model, an API call based on the video game information to be collected and the location; and
insert the API call into the video game codebase at the location, the API call configured to request the video game information.

14. The computing system of claim 13, wherein a plurality of API calls are inserted in the video game codebase including the API call, and wherein the sequence of instructions that, when executed, further cause the one or more processors to:
process a merge request associated with the API call and the video game codebase, the merge request for permitting a respective acceptance or rejection of each API call of the plurality of API calls; and
update the machine learning model based on the respective acceptance or rejection of each API call.

15. The computing system of claim 13, wherein the API call is configured to collect information for an artificial intelligence (AI) agent configured to execute the video game codebase, and wherein the sequence of instructions that, when executed, further cause the one or more processors to:
monitor a gameplay of the AI agent while executing the video game codebase;
determine an association between the video game information collected via the API call and the gameplay; and
update the input based on the association.

16. The computing system of claim 15, wherein the sequence of instructions that, when executed, further cause the one or more processors to:
determine that the gameplay of the AI agent can be modified based on second video game information; and
insert a second API call into the video game codebase for collecting the second video game information.

17. The computing system of claim 13, wherein the input comprises a JavaScript Objection Notation (JSON) file indicating a type of video game information to be collected, a structure of the video game information to be collected, and an endpoint for an AI agent configured to execute the video game codebase.

18. One or more non-transitory, computing readable media comprising a sequence of instructions that, when executed, cause one or more processors to:
generate an application programming interface (API) call based on video game information to be collected during execution of a video game codebase by an artificial intelligence (AI) agent;
insert the API call into the video game codebase;
process gameplay information of the AI agent executing the video game codebase; and
update the API call based on the gameplay information.

19. The one or more non-transitory, computing readable media of claim 18, wherein the sequence of instructions that, when executed, further cause the one or more processors to:
insert a second API call into the video game codebase based on the gameplay information.

20. The one or more non-transitory, computing readable media of claim 18, wherein the sequence of instructions that, when executed, further cause the one or more processors to:
process a message from the AI agent during execution of the video game codebase;
generate a second API call based on the message; and
insert the second API call in the video game codebase during execution of the video game codebase by the AI agent.
